(19) United States
(12) Patent Application Publication
(10) Pub. No.: US 2026/0346060 A1
(43) Pub. Date: Nov. 5, 2026

(54) MASK INCLUDING OXYGEN GENERATING COMPOSITION AND MANUFACTURING METHOD THEREFOR

(71) Applicant: SAVING STORY, Gyeonggi-do (KR)

(72) Inventor: Seung JANG, Gyeonggi-do (KR)

(73) Assignee: SAVING STORY, Gyeonggi-do (KR)

(21) Appl. No.: 19/398,634

(22) Filed: Nov. 24, 2025

Related U.S. Application Data
(63) Continuation of application No. PCT/KR2025/009137, filed on Jun. 27, 2025.

(30) Foreign Application Priority Data
Jul. 26, 2024 (KR) 10-2024-0099611

(51) Int. Cl. A62B 21/00; A41D 13/11; A62B 23/02

(52) U.S. Cl. CPC A62B 21/00; A41D 13/113; A41D 13/1161; A62B 23/025

(57) ABSTRACT

Provided are a mask including an oxygen generating composition capable of being used in disaster situations such as fires or in high-altitude areas where oxygen is insufficient, and a method for manufacturing the same. The mask including the oxygen generating composition includes: a filter sheet; an oxygen generating container coupled to the filter sheet; an oxygen generating substance stored in a sealed state inside the oxygen generating container; and wearing straps connected to both ends of the filter sheet, wherein the wearing straps include at least two first wearing straps and second wearing straps of different lengths.

### CROSS-REFERENCE TO RELATED APPLICATIONS

This application is a continuation of International Application No. PCT/KR2025/009137 filed on Jun. 27, 2025, which claims priority to Korean Patent Application No. 10-2024-0099611 filed on Jul. 26, 2024, the entire contents of which are herein incorporated by reference.

### TECHNICAL FIELD

The present disclosure relates to a mask capable of supplying oxygen to a user by including an oxygen generating composition in a container and generating oxygen through a reaction in the event of an emergency, and a method for manufacturing the same. In addition, the present disclosure relates to a protective mask capable of swiftly generating and supplying oxygen in the event of an emergency disaster such as a fire or explosion, thereby blocking toxic gases from entering the respiratory tract of a person and thus preventing casualties. In addition, the present disclosure relates to a mask capable of smoothly supplying oxygen to a user in an oxygen-deficient situation such as a high-altitude area, and urgently providing oxygen in the event of an emergency due to oxygen deprivation to prolong the life of the user.

### BACKGROUND ART

In the event of a disaster such as a fire or explosion, the main cause of casualties is not the direct flame, but the smoke and toxic gases that are generated and spread in the air. Moreover, citizens who are vulnerable to disasters frequently miss the golden time for evacuation due to inhalation of toxic gases or suffocation from smoke.

In the event of a disaster such as a fire or explosion, it is important to avoid the flame, but, first of all, one is required to cover the respiratory tract such as the nose and mouth to prevent inhalation of toxic gases and smoke containing a large amount of toxic substances and to prevent life-threatening situations such as brain damage or cardiac arrest due to inadequate supply of oxygen, thereby securing the golden time and surviving long enough for rescue teams to arrive, ultimately preventing casualties.

In the past, it was common to cover the mouth and nose with a wet towel in the event of an emergency to prevent inhalation of toxic gases and smoke. However, in the event of a disaster, a method of finding a towel and wetting the same with water is cumbersome and takes more time to prepare, which may in the meantime lead to a dangerous situation where one is exposed to and inhales toxic gases. In addition, when the respiratory tract is blocked with a towel, it is difficult for young children or the elderly to breathe normally, and it is difficult for evacuees to actively take initial action or swiftly evacuate a disaster site while keeping the towel tightly attached to their hands and respiratory tract.

There is a need for a product capable of effectively blocking toxic gases or smoke that may enter the human respiratory tract while also swiftly supplying oxygen to a user, thereby extending survival time.

In high-altitude areas, oxygen becomes scarce as the altitude increases. Thus, people climbing high-altitude areas may feel dizzy due to a lack of oxygen, and in severe cases, some people may lose consciousness or their life. In particular, climbers who climb very high-altitude mountains around the world, such as the Himalayas, are likely to encounter environments where oxygen is scarce. In preparation thereof, while climbing, many climbers often carry oxygen cans, which store oxygen inside a separate can. However, oxygen cans occupy a lot of space and are heavy, making it difficult and inconvenient to carry the same for long periods of time while climbing. Therefore, there is a need for a product that is easy to carry and is capable of urgently providing oxygen when an abnormality occurs in the body due to a lack of oxygen.

### DISCLOSURE

### Technical Problem

An aspect of the present disclosure is directed to providing a mask capable of effectively blocking toxic gases or smoke that may enter the respiratory tract of a person in the event of an emergency while swiftly supplying oxygen to a user, thereby extending survival time, and a method for manufacturing the same.

In addition, there are provided a mask that is easy to carry while immediately supplying oxygen when needed in high-altitude areas such as oxygen-deficient environments, and a method for manufacturing the same.

In addition, there are provided a mask that may be worn by multiple people with various face shapes and sizes and a method for manufacturing the same.

In addition, there are provided a mask, which prevents undesired generation of oxygen even when an oxygen generating substance is stored for a long period of time by maintaining excellent airtightness before use of the oxygen generating substance sealed and stored in an oxygen storage container, and a method for manufacturing the same.

In addition, there are provided a mask, which has excellent durability and thus may prevent other components coupled to a filter of the mask from being undesirably separated or damaged, and a method for manufacturing the same.

In addition, there is provided a method for manufacturing a mask in which multiple components coupled to a mask filter are correctly coupled at more precise locations.

The aspects of the present disclosure are not limited to those mentioned above, and other aspects not mentioned herein will be clearly understood by those skilled in the art from the following description.

### Technical Solution

A mask according to an embodiment of the present disclosure includes: a filter sheet; an oxygen generating container coupled to the filter sheet; an oxygen generating substance stored in a sealed state inside the oxygen generating container; and wearing straps connected to both ends of the filter sheet, wherein the wearing straps include at least two first wearing straps and second wearing straps of different lengths.

In addition, the first wearing straps and the second wearing straps may be bonded at the same point in the filter sheet.

In addition, the first wearing strap and the second wearing strap may be ultrasonically bonded to the filter sheet.

In addition, there may be further included a first reinforcing strap that is physically coupled while penetrating the filter sheet with the first wearing straps and the second wearing straps interposed in the filter sheet.

In addition, the first wearing straps and the second wearing straps may be formed of an elastic material and the first wearing straps may be shorter than the second wearing straps, and the first wearing straps may be less elastic than the second wearing straps.

In addition, the filter sheet may have a first surface and a second surface facing each other bonded by ultrasonic bonding, and the mask may further include a second reinforcing strap, at a distal end where the first surface and the second surface face each other, that repeatedly passes through the first surface and the second surface and is physically coupled.

In addition, there may be further included a liquid natural extract contained in the filter sheet.

In addition, the oxygen generating container may be coupled both to the first surface and the second surface.

In addition, the oxygen generating container may include: a container body that is coupled to the filter sheet, and includes an edge portion having one side open and the other side closed to form an accommodation space and bent in a flange shape and a step formed by being bent in an inner accommodation space; a barrier frame that includes a plurality of air passages, is accommodated inside the container body, and is seated on and coupled to the step; and a cover member that is coupled to an upper end of the edge portion of the container body to seal the oxygen generating substance inside.

In addition, the cover member may include a protruding area protruding further from the edge portion of the container body, the mask may further include an operating portion coupled to the protruding area of the cover member, and the protruding area to which the operating portion of the cover member is coupled may be disposed in a downward direction based on a face of a user.

In addition, the operating portion may include a first plate disposed on one surface of

the cover member and including a groove portion, and a second plate disposed on the other surface of the cover member and including a protruded coupling pillar, wherein the coupling pillar may penetrate the cover member and be coupled to the groove portion, and the first plate and the second plate may be formed integrally and coupled to the cover member in a folded state at one end.

In addition, the barrier frame may further include a hole or a protruded projection portion, and the container body may further include a projection portion or a hole that faces and forms a concavo-convex ( [symbol] ) coupling with the hole or protruded projection portion of the barrier frame.

In addition, a height from the step of the container body to an upper end of the edge portion of the container body may be equal to or higher than a height from the step of the container body to an upper end of the barrier frame.

In addition, the barrier frame may be disposed spaced apart from the cover member inside of the container body.

An embodiment of the present disclosure provides a method for manufacturing the mask, wherein the method for manufacturing the mask according to an embodiment of the present disclosure includes: preparing a filter sheet; interposing and disposing, on one surface of the filter sheet, a rear surface of an edge portion of a container body including the edge portion having one side open and the other side closed to form an accommodation space and bent in a flange shape and a step formed by being bent in an inner accommodation space; coupling the container body coupled by disposing a coupling frame while facing the rear surface of the edge portion of the container body with the filter sheet interposed therebetween; disposing a bag accommodating an oxygen generating substance in the accommodation space of the container body; disposing a barrier frame including a plurality of air passages by accommodating and disposing the same inside the container body and seating and coupling the same to the step; coupling and sealing a cover member to an upper end of the edge portion of the container body; and bonding wearing straps including two or more first wearing straps and second wearing straps of different lengths at both ends of the filter sheet.

In addition, the coupling of the container body may be configured to couple the rear surface of the edge portion of the container body and the coupling frame by ultrasonic welding while interposing the filter sheet, and the sealing may be configured to couple an upper surface of the edge portion of the container body and the cover member by ultrasonic welding.

In addition, the bonding of the wearing straps may be configured to bond the first wearing straps and the second wearing straps simultaneously, wherein the first wearing straps and the second wearing straps may be formed of an elastic material, the first wearing straps may be shorter than the second wearing straps, and the first wearing straps may be less elastic than the second wearing strap.

Specific details of other embodiments are included in the detailed description and the drawings.

### Advantageous Effects

According to the embodiments of the present disclosure, at least the following benefits are provided.

A mask and a method for manufacturing the same according to an embodiment of the present disclosure can effectively block toxic gases or smoke that may enter the respiratory tract of a person in the event of an emergency while swiftly supplying oxygen to a user, thereby extending survival time.

In addition, there is provided the mask that is easy to carry while immediately supplying oxygen when needed in high-altitude areas such as oxygen-deficient environments.

In addition, the mask can be worn by multiple people with various face shapes and sizes.

In addition, undesired generation of oxygen can be prevented even when an oxygen generating substance is stored for a long period of time by maintaining excellent airtightness before use of the oxygen generating substance sealed and stored in an oxygen storage container.

In addition, the mask has excellent durability, and thus can prevent other components coupled to a filter of the mask from being undesirably separated or damaged.

In addition, the manufacturing accuracy can be improved by ensuring that multiple components coupled to a mask filter are correctly coupled at more precise locations.

The benefits of the present disclosure are not limited to the contents exemplified above, and more various benefits are included in the present specification.

### DESCRIPTION OF DRAWINGS

FIG. 1 is a view of a mask according to an embodiment of the present disclosure viewed from one direction.

FIG. 2 is a view of a mask according to an embodiment of the present disclosure viewed from another direction.

FIG. 3 is a view of a mask according to an embodiment of the present disclosure as viewed from the direction in which a user wears the mask.

FIG. 4 is a view of a mask according to another embodiment of the present disclosure as viewed from the direction in which the user wears the mask.

FIG. 5 is an exploded perspective view schematically illustrating how each component of an oxygen generating container is coupled to a filter sheet in a mask according to an embodiment of the present disclosure.

FIG. 6 is a diagram illustrating a state of use of a mask according to an embodiment of the present disclosure.

FIG. 7 is a diagram schematically illustrating the relationship in which a cover member is coupled to a container body of an oxygen generating container in a mask according to an embodiment of the present disclosure.

FIG. 8 is a diagram illustrating a barrier frame of an oxygen generating container in a mask according to an embodiment of the present disclosure.

FIG. 9 is a diagram illustrating an operating portion coupled to a cover member in a mask according to an embodiment of the present disclosure.

FIG. 10 is a diagram illustrating a cross-section taken along line A-A′ in FIG. 7 according to an embodiment.

FIG. 11 is a diagram illustrating a cross-section taken along line A-A′ in FIG. 7 according to another embodiment.

FIG. 12 is a diagram illustrating a cross-section taken along line A-A′ in FIG. 7 according to yet another embodiment.

### MODE FOR INVENTION

The features and advantages of the present disclosure and the method to achieve the same will become more apparent from the following detailed description in conjunction with the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the present disclosure to those skilled in the art, and the present disclosure will only be defined by the appended claims. Like reference numerals refer to like elements throughout the specification. In the drawings, sizes and relative sizes of layers and regions may be exaggerated for clarity.

Spatially relative terms, such as “beneath,” “below,” “lower,” “above,” “upper” and the like, may be used herein for ease of description to describe one element or feature's relationship to another element(s) or feature(s) as illustrated in the figures.

In this specification, although the terms first, second, etc. may be used to describe various elements, it should be understood that these elements are not limited by these terms. These terms are only used to distinguish one element from another. Therefore, a first element could be termed as a second element without departing from the scope of exemplary embodiments of the present disclosure.

For convenience of description, the drawings illustrated for description of various embodiments of the present disclosure may be exaggerated in terms of each component, and a relative size, height, and length ratio between components.

Hereinafter, embodiments of the present disclosure will be described with reference to the drawings.

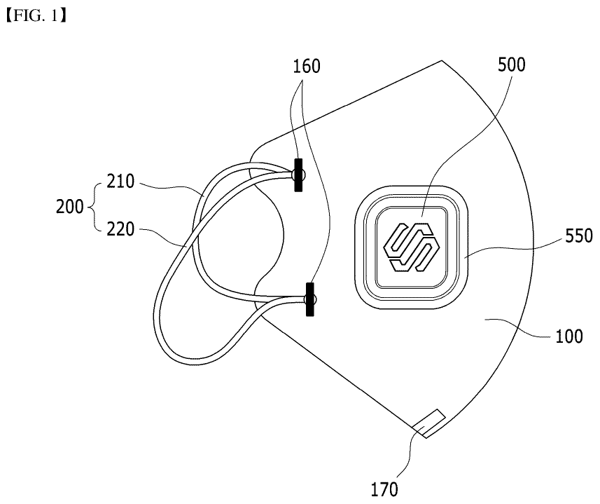

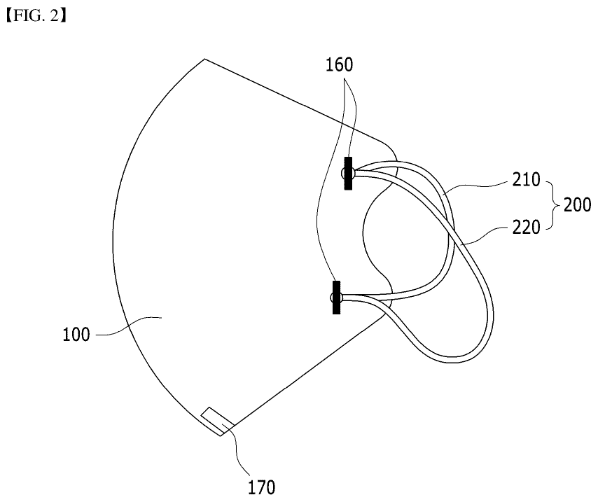

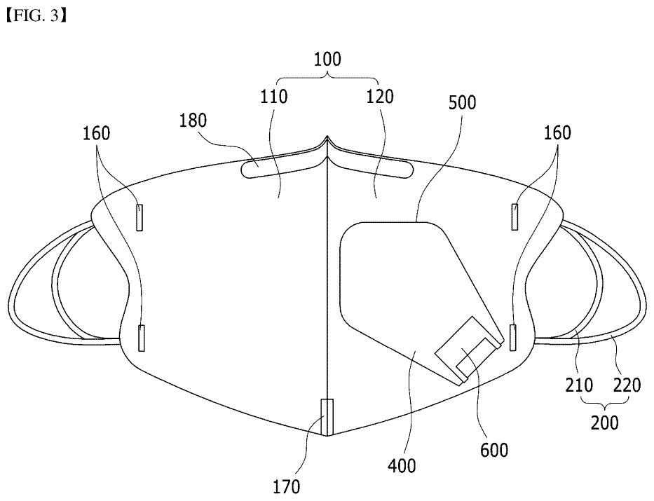

FIG. 1 is a view of a mask according to an embodiment of the present disclosure viewed from one direction. FIG. 2 is a view of a mask according to an embodiment of the present disclosure viewed from another direction. FIG. 3 is a view of a mask according to an embodiment of the present disclosure as viewed from the direction in which a user wears the mask.

Referring to FIGS. 1 to 3, a mask according to an embodiment of the present disclosure includes a filter sheet 100, an oxygen generating container 500 coupled to the filter sheet 100, an oxygen generating substance 10 stored in a sealed state inside the oxygen generating container 500, and a wearing strap 200 connected to both ends of the filter sheet 100, wherein the wearing strap 200 includes at least two first wearing straps 210 and second wearing straps 220 of different lengths.

The mask of an embodiment of the present disclosure may be used in dangerous disaster situations such as a fire. In this connection, it is possible to block toxic gases from entering the respiratory tract of a user. To this end, a separate blocking filter disposed on the filter sheet 100 may be additionally included. In addition, a liquid natural extract may be included in the filter sheet 100 to provide a sense of stability to a user while blocking harmful gases. In addition, the mask of an embodiment of the present disclosure may be used to urgently supply oxygen to climbers in case of an emergency in an oxygen-scarce high-altitude area, or to supply oxygen to a person in need of oxygen by reaction. The filter sheet of the mask used to this end may not contain a separate liquid extract. The mask of an embodiment of the present disclosure may provide oxygen to a user even in an oxygen-free environment by opening the oxygen generating container only when necessary and generating oxygen through a reaction of the oxygen generating substance. In addition, the mask occupies little space, making it easy to store and carry, and thus is convenient for users to use.

The filter sheet 100 may be formed in a state where a first surface 110 and a second surface 120 are bonded to each other. In addition, the filter sheet 100 may have various filter layers as needed. For example, the filter sheet 100 may include a first layer composed of a material including rayon, a second layer composed of a material including activated carbon in a polypropylene material, a third layer composed of a melt-blown filter including a polypropylene material, a fourth layer composed of a material including activated carbon in a polypropylene material, and a fifth layer composed of a material including rayon. By providing the filter sheet 100 in which the first to fifth layers are sequentially disposed, external harmful gases may be blocked. In other words, harmful gases such as carbon dioxide, formaldehyde, sulfur dioxide, nitrogen dioxide, and ammonia may be filtered out. However, it is not limited thereto.

The filter sheet 100 may contain a liquid natural substance extract. The natural substance extract may include at least one selected from the group consisting of propolis extract, green tea extract, tea tree extract, lavender extract, rosemary flower extract, peppermint extract, corn mint leaf extract, Matricaria extract, and water lily flower extract.

Due to the extract, the mask may perform the function of blocking harmful gases and may be utilized as a gas mask. The filter sheet 100 that functions as a harmful gas filter layer contains natural extracts to block external harmful gases and prevent harmful gases from entering the respiratory tract of a user in emergency situations such as a fire, and oxygen is generated from the oxygen generating substance into the respiratory tract of the user to allow survival for as long as possible. Furthermore, the mask of an embodiment of the present disclosure has the wearing straps 200 coupled to both ends so as to be hung on both ears of a user, thereby blocking harmful gases and supplying oxygen while allowing the user to evacuate more conveniently without having to use hands separately.

The filter sheet 100 may include at least one ingredient selected from the group consisting of, for example, Boswellia, ylang-ylang, cinnamon, neroli, bergamot, lemongrass, sweet orange, lavender, rose, rosemary, clary sage, Roman chamomile, and peppermint essential oils in addition to the natural extracts, and these extracts may be additionally used. By impregnating the filter sheet 100 with the extract, it is possible to provide a sense of stability to a user together with the oxygen generated from the oxygen generating substance and block toxic gases.

More specifically, the Boswellia essential oil is made from the resin of trees of the genus Boswellia, and the main common components are a-pinene, limonene, a-thujene, myrcene, sabinene, and para-cymene, which may have anxiolytic properties and affect sleep and wakefulness behavior.

In addition, the ylang-ylang essential oil may be extracted by distilling the flowers and stems of the ylang-ylang tree, and is composed of 150 molecules including monoterpenes, sesquiterpenes, aliphatic compounds, phenylpropanoids, and nitrogen-containing compounds, and the main components benzyl benzoate, linalool, and benzyl alcohol may help relieve anxiety and have a sedative effect.

In addition, the cinnamon essential oil is extracted from the brown bark of the Cinnamomum verum tree, and most of its components are phenolic compounds. The main active compounds of sesquiterpene and monoterpene hydrocarbons control the secretion of adrenaline, which helps treat depressive disorders and provides a sense of stability to a user.

In addition, the neroli essential oil is obtained by distilling the flowers of the bitter orange tree and is rich in limonene, β-myrcene, and β-pinene, which may significantly reduce stress levels and have a noticeable effect in relieving menopausal symptoms.

In addition, the bergamot essential oil is obtained by extracting the epicarp and mesocarp of the bergamot fruit and is mainly composed of limonene, linalyl acetate, and linalool, and these compounds may minimize symptoms of anxiety and mild mood disorders caused by stress. The bergamot essential oil has been involved in anxiolytic and antidepressant properties, which may provide users with a sense of stability.

In addition, the lemongrass essential oil is obtained by hydrodistillation from the leaves of lemongrass, and is mostly composed of citral such as neral and geranial. The compounds of β-myrecene, limonene, citronellol, geraniol, 1,8-cineole, neroli, a-terpineol, borneol, eugenol, geranyl acetate, and elemicin contained in the relevant ingredients may significantly reduce anxiety and subjective tension.

In addition, the sweet orange essential oil is obtained from the bark of the sweet orange tree by cold pressing with highly volatile compounds such as d-limonene, β-myrcene, a-pinene, sabinene, linalool, geranial, and neral, and may significantly reduce the concentration of oxyhemoglobin in the right prefrontal cortex and increase the feeling of comfort, thereby providing powerful anxiety relief.

In addition, the lavender essential oil is extracted from lavender flowers by steam distillation, and its main compounds are composed of linalyl acetate, linalool, lavandulyl acetate, myrcene, terpinen-4-ol, terpineol, cis-linalool oxide, trans-linalool oxide, and ocimene. The lavender essential oil may treat mild stress and anxiety, and has been shown to be significantly beneficial on the quality and duration of sleep, making it effective in alleviating symptoms of anxiety disorders.

In addition, the rose essential oil may be obtained by distilling the flowers of Rosa damascena. The majority of the ingredients of rose essential oil are monoterpene alcohol, and other ingredients such as 2-phenethyl alcohol, citronellol, geraniol, methyl eugenol, and eugenol may significantly improve the quality of sleep and relieve anxiety by increasing blood oxygen saturation and reducing autonomous arousal.

In addition, the rosemary essential oil is obtained by distilling the aerial parts of rosemary and is composed of 16 compounds, namely cineole, camphor, α-pinene, camphene, and α-terpineol. The α-pinene may be involved in anxiety-relieving properties and may improve memory and mood.

In addition, the clary sage essential oil is obtained by distilling the entire aerial part of clary sage, and the compounds of linalool, α-terpineol, geraniol, geraniol acetate, and myrcene acetate contained therein may be involved in an antidepressant effect and exhibit remarkable anxiolytic properties.

In addition, the Roman chamomile essential oil is an oil distilled from the flower head of Roman chamomile, and its constituent compounds such as isobutyl angelate, isoamyl angelate, and 2-methylbutyl isobutyrate show a psychostimulant effect and may have anxiolytic and sedative actions.

In addition, the peppermint essential oil is obtained by steam distillation from the leaves of peppermint, and among the compositions consisting of 26 or more compounds, menthol and iso-menthone make up the majority. The relevant ingredients may improve concentration and memory.

The oxygen generating container 500 is couped to the filter sheet 100 to store the oxygen generating substance 10 inside, and is sealed by a cover member 400 to prevent oxygen from being generated before use. The oxygen generating container 500 may be configured in such a way that a container body penetrates and is coupled to a cut area formed in a portion of the filter sheet 100, with one end completely sealed (closed) and the other end being bent in a flange shape to form an edge portion and open. The cover member 400 may be coupled to the edge portion of the container body to seal the open portion by isolating the same from the outside. In other words, the closed portion of the oxygen generating container 500 may be defined as facing outward opposite the face of a user, and the open portion may be defined as facing inward facing the face of the user so as to supply oxygen to the respiratory tract of the user. The container body may be fixed to the filter sheet 100 by a coupling frame 550. In other words, the oxygen generating container 500 may be fixed to the filter sheet by coupling the container body and the coupling frame 550 with the filter sheet 100 interposed between a portion of the container body and the coupling frame 550.

The oxygen generating substance 10 may include, for example, potassium peroxide (KO₂) and calcium hydroxide (Ca(OH)₂), and the weight ratio of the potassium peroxide to the calcium hydroxide may be in the range of 8:2 to 5:5. A reaction may occur to produce water (H2O) by carbon dioxide transmitted from the respiratory tract of a user or carbon dioxide transmitted from the surroundings by the calcium hydroxide, and the potassium peroxide may react with the produced water to generate oxygen (O₂).

For example, an oxygen generating composition of an embodiment of the present disclosure may generate oxygen according to sequential reactions such as the following reaction formulas (1) and (2). In other words, as shown in the following reaction formula (1), calcium hydroxide (Ca(OH)₂) may produce calcium carbonate (CaCO₃) and water (H₂O) by carbon dioxide (CO₂) generated from the mouth or nose of a user or introduced from the surroundings, and water (H₂O) produced by the reaction formula (1) may react with the potassium peroxide (KO₂) through the reaction of the following reaction formula (2) to produce oxygen (O₂), potassium hydroxide (KOH), and hydrogen peroxide (H₂O₂) products and ultimately generate oxygen.

Ca(OH)₂+CO₂→CaCO₃+H₂O Reaction Formula (1)

2KO₂+2H₂O→O₂+2KOH+H₂O₂ Reaction Formula (2)

By satisfying the weight ratio of the potassium peroxide to the calcium hydroxide in the range of 8:2 to 4:6, oxygen may be generated more quickly and more oxygen may be generated compared to the carbon dioxide introduced. Preferably, for example, the weight ratio of the potassium peroxide to the calcium hydroxide may be in the range of 8:2 to 5:5, in the range of 7:3 to 5:5, in the range of 7.5:2.5 to 5.5:4.5, or in the range of 7:3 to 6:4. When the content of potassium peroxide is excessively large, for example, when the weight ratio of the potassium peroxide to the calcium hydroxide exceeds 8:2, the moisture generated in the first reaction with the calcium hydroxide may react with the powdered compound to form a paste, which may delay the reaction.

The oxygen generating composition may further include manganese dioxide (MnO₂). By including the manganese dioxide, more oxygen may be generated. For example, when H₂O₂ is produced through the above reaction formula (2), oxygen and water are additionally generated through a reaction such as the following reaction formula (3), and the additionally produced water may then be used to generate more oxygen through the process of the above reaction formula (2).

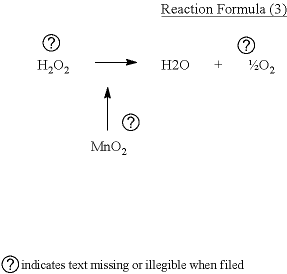

For example, the manganese dioxide (MnO₂) may be in a range of 5 to 20 parts by weight relative to 100 parts by weight of the potassium peroxide and the calcium hydroxide. Oxygen may be generated more quickly while ensuring a sufficient amount of oxygen generated within the above range.

The oxygen generating composition may further include potassium nitrate (KNO₃) or potassium chloride (KCl). In the process of carrying out the reaction in which the oxygen generating composition reacts with carbon dioxide and ultimately generates oxygen through the water produced thereby, a rapid exothermic reaction may occur, and ultimately, the oxygen generating composition may rise to a high temperature due to the high reaction temperature. In this connection, a user may experience skin damage or respiratory tract damage due to high temperatures. By including potassium nitrate (KNO₃) or potassium chloride (KCl) as described above, the heat generated by the reaction may be absorbed, thereby preventing the temperature from rising during the process of the oxygen generating substance reacting to generate oxygen. Thus, a user may be enabled to use the oxygen generating substance more safely.

For example, the potassium nitrate or the potassium chloride may be in a range of 100 to 240 parts by weight relative to 100 parts by weight of the potassium peroxide and the calcium hydroxide. It is possible to effectively control the exothermic reaction while having a sufficient amount of oxygen generated in the above range.

In addition, the potassium nitrate or the potassium chloride may be included in a range of 3 to 5 times the weight ratio of the potassium peroxide, and for example, the potassium nitrate or the potassium chloride may be included in a range of 3.5 to 4.5 times the weight ratio of the potassium peroxide. In the above range, it is possible to effectively prevent the temperature from rising due to an exothermic reaction when the oxygen generating substance reacts, while also preventing an amount of oxygen generated from decreasing. In other words, when the amount of potassium nitrate or potassium chloride is less than three times, the temperature rise control effect may be minimal, and when exceeding five times, a paste phenomenon may occur frequently, which may reduce the amount of oxygen generated. Accordingly, it is possible to effectively control the temperature within the above range while generating a large amount of oxygen.

The oxygen generating composition may further include sodium bicarbonate (NaHCO₃). The sodium bicarbonate may cause the oxygen generating composition to generate an excess amount of oxygen during the initial reaction, thereby enabling the immediate generation of an excess amount of oxygen in an emergency situation, and in particular, may enable the generation of a large amount of oxygen more quickly in a disaster situation such as a fire in which toxic gases spread. For example, the substances produced by the above reaction formulas (1) and (2) may be basic, and by adding the sodium bicarbonate, the basicity may be neutralized by an acid-base reaction, thereby promoting the reaction so that the reactions of the above reaction formulas (1) and (2) proceed actively. As a result, by removing the KOH compound produced by the reaction formula (2) through an acid-base reaction with the sodium bicarbonate, the reaction may be made to progress more toward a product, thereby generating a lot of oxygen quickly.

The sodium bicarbonate may be included in a range of 20 to 40 parts by weight relative to 100 parts by weight of the potassium peroxide and the calcium hydroxide. Oxygen may be generated more quickly while ensuring a sufficient amount of oxygen generated within the above range.

The oxygen generating composition may further include silica (SiO₂). During the process of generating oxygen by reacting the potassium peroxide and the calcium hydroxide, the amount of oxygen generated may be reduced due to lump formation caused by an agglomeration phenomenon. However, by further including the silica, the agglomeration phenomenon may be prevented, thereby ensuring that the amount of oxygen generated is sufficient. The silica may be included in an amount of 10 to 40 parts by weight, or in an amount of 10 to 30 parts by weight, based on 100 parts by weight of the potassium peroxide and the calcium hydroxide. It is possible to prevent the agglomeration phenomenon while ensuring a sufficient amount of oxygen generated within the above range.

The oxygen generating substance 10 may be stored inside a bag with micropores formed therein and positioned inside the oxygen generating container 500. The oxygen generating substance is in the form of a mixed powder and is stored inside a bag with micropores formed therein to prevent the oxygen generating substance from leaking out, and when oxygen is generated, oxygen may be released to the outside (to the respiratory tract of a user) through the micropores. The bag may be disposed inside the oxygen generating container 500 and maintained in a sealed state by the cover member 400 while preventing the same from leaking to the outside by a barrier frame 300. When the bag is sealed by the cover member 400, no separate reaction occurs, and thus the oxygen generating substance may exist in a powder state. When the cover member 400 is removed, carbon dioxide (from the breath of a user or the surrounding air) is supplied from the outside, and moisture (from moisture present in the breath of the user or moisture present in small amounts in the surroundings) is supplied, a reaction begins in which oxygen is generated. The oxygen generated thereafter may pass through the pores of the bag and provide oxygen to the respiratory tract of a user.

The wearing strap 200 may be connected to both ends of the filter sheet 100 and include at least two first wearing straps 210 and second wearing straps 220 of different lengths. By including the first wearing straps 210 and second wearing straps 220 of different lengths, the mask may be easily used by users with different face sizes. For example, when a user has a small face like a child, the user may wear the mask on the face using short length wearing straps, and when a user has a relatively large face like an adult, the user may wear the mask on the face using long length wearing straps. Accordingly, in case of an emergency, men and women of all ages may quickly and easily wear a mask to escape the emergency.

The first wearing straps 210 and the second wearing straps 220 may be bonded at the same point in the filter sheet 100. By bonding the same at the same point, the area where the filter function progresses in the mask may be secured to the maximum extent. In addition, the first wearing straps 210 and the second wearing straps 220 may be ultrasonically bonded to the filter sheet 100. By disposing the first wearing straps 210 and the second wearing straps 220 in the same position and then simultaneously bonding the same with ultrasonic waves, the bonding force may be increased and the two wearing straps 200 may be coupled to the writing sheet 100 in a simplified process. In addition, a stronger bonding force may be secured by performing ultrasonic bonding only once. When ultrasonic bonding is performed several times, the portion bonded first may be separated by the portion bonded later. This issue may be prevented by performing ultrasonic bonding simultaneously.

In addition, the first wearing straps 210 and the second wearing straps 220 may be formed of an elastic material, but the first wearing straps 210 may be shorter than the second wearing straps 220, and the first wearing straps 210 may have a lower elastic force than the second wearing straps 220. In other words, when the first wearing straps 210 having a short length are stretched, the restoring force to return to the original length is weaker than the second wearing straps 220, and thus may be stretched longer with less force. Accordingly, when the first wearing straps 210 and the second wearing straps 220 are coupled to the same point of the filter sheet 100, the force applied to the first wearing straps 210 and the second wearing straps 220 in the mechanical device that performs coupling may be adjusted to a level that is almost equivalent to each other, thereby enabling the coupling to be performed at a more precise position.

More specifically, in a mass production process of a continuous process, when the filter sheet 100 moves, the first wearing straps 210 and the second wearing straps 220 may be pulled to start at the same position and be bonded to the same position of the filter sheet 100 by a mechanical device or configuration, thereby forming a bond. In this connection, since the elastic force of the first wearing straps 210 having a short length is formed weakly, the restoring force generated when the first wearing straps 210 and the second wearing straps 220 are stretched is formed weaker for the first wearing straps 210. As a result, the force applied to the mechanical device by the first wearing straps 210 and the second wearing straps 220 may be adjusted to an equivalent level. Accordingly, it is possible to prevent an error from occurring in the position where the first wearing straps 210 and the second wearing straps 220 are coupled due to different forces (elastic force, restoring force).

There may be further included a first reinforcing strap 160 that is physically coupled while penetrating the filter sheet 100 in a state in which the first wearing straps 210 and the second wearing straps 220 are interposed in the filter sheet 100. The first wearing straps 210 and the second wearing straps 220 may be bonded to the filter sheet 100 by ultrasonic bonding for a mass production process. When a strong force is applied to the wearing strap 200, the phenomenon of separation from the filter sheet 100 may occur. In addition, when the filter sheet 100 contains liquids such as various extracts in order for the mask to be used in disaster situations such as a fire, the bonding force of the wearing strap 200 may become weaker. Accordingly, the first reinforcing strap 160 is physically coupled while penetrating the filter sheet 100 in a state in which the first wearing straps 210 and the second wearing straps 220 are interposed in the filter sheet 100, thereby effectively preventing the wearing strap 200 from being separated from the filter sheet 100.

The filter sheet 100 may further include a second reinforcing strap 170 in which a first surface 110 and a second surface 120 facing each other are bonded by ultrasonic bonding, and at the distal end where the first surface 110 and the second surface 120 face each other, the first surface 110 and the second surface 120 repeatedly pass and are physically coupled. The filter sheet 100 is configured such that the first surface 110 and the second surface 120 that are symmetrical to each other are connected at an upper end (or a lower end), and the central curved portions are bonded to each other to form a three-dimensional shape. The central portions may be bonded by ultrasonic welding. Accordingly, the distal ends of the portions that are not connected and are bonded by ultrasonic welding may be separated with relatively little force. Accordingly, the second reinforcing strap 170 repeatedly passes through the first surface 110 and the second surface 120 to physically couple the same, thereby preventing the first surface 110 and the second surface 120 from being easily separated. In particular, when the mask of an embodiment of the present disclosure is used for fire evacuation and the filter sheet 100 contains a liquid extract, separation of the first surface 110 and the second surface 120 may occur more easily, so the separation of the filter sheet 100 may be more effectively prevented by the second reinforcing strap 170.

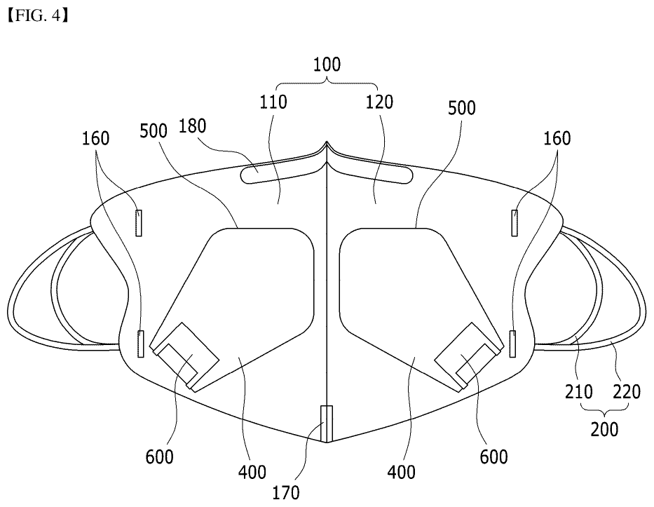

FIG. 4 is a view of a mask according to another embodiment of the present disclosure as viewed from the direction in which the user wears the mask.

Referring to FIG. 4, the oxygen generating container 500 may be coupled to both the first surface 110 and the second surface 120. In other words, the masks of FIGS. 1 to 3 have the oxygen generating container coupled to only one surface of the mask, but as in FIG. 4, the oxygen generating containers may be coupled to both surfaces of the mask to provide more oxygen. A user may appropriately adjust the coupling of the oxygen generating container(s) to one or both surfaces of the mask as needed.

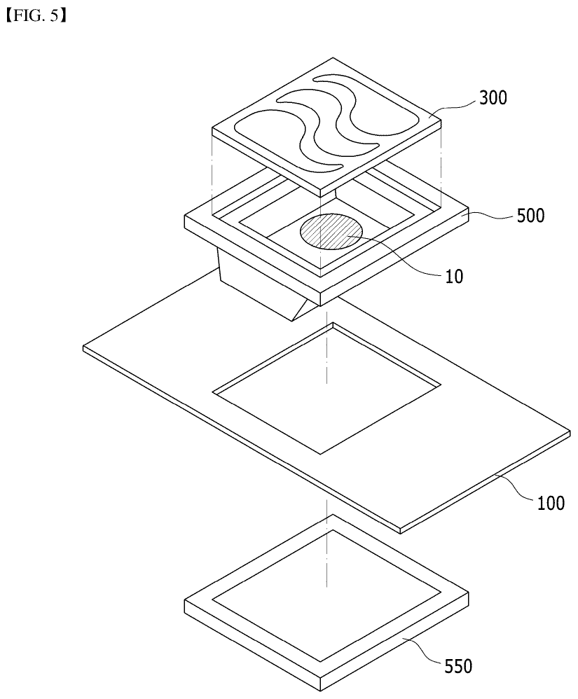

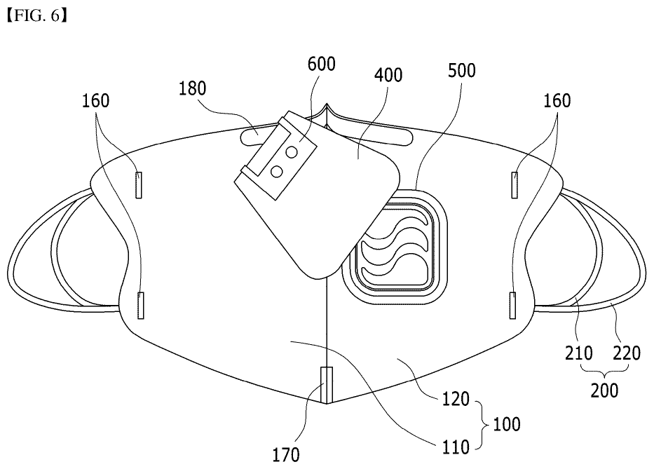

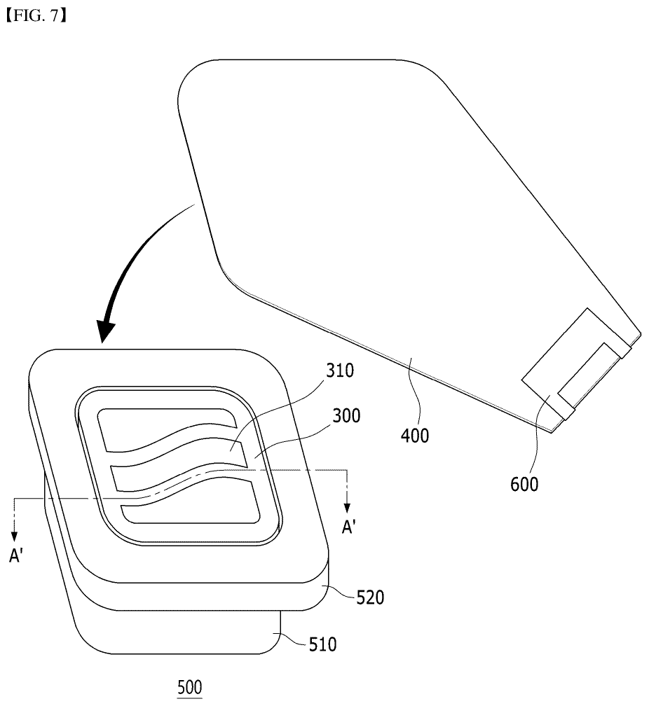

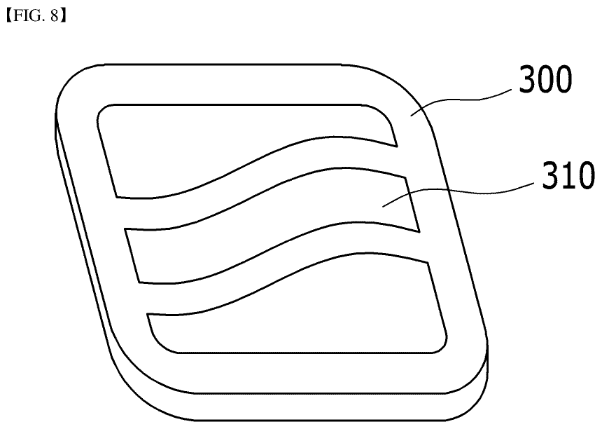

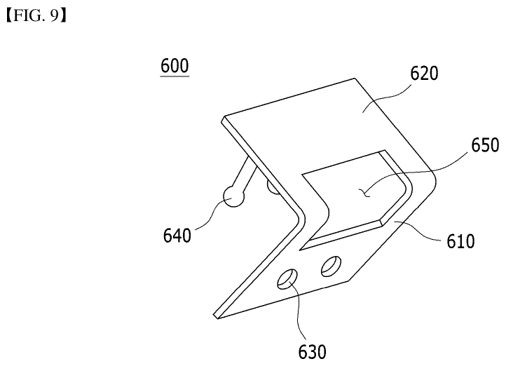

FIG. 5 is an exploded perspective view schematically illustrating how each component of an oxygen generating container is coupled to a filter sheet in a mask according to an embodiment of the present disclosure. FIG. 6 is a diagram illustrating a state of use of a mask according to an embodiment of the present disclosure. In addition, FIG. 7 is a diagram schematically illustrating the relationship in which a cover member is coupled to a container body of an oxygen generating container in a mask according to an embodiment of the present disclosure. FIG. 8 is a diagram illustrating a barrier frame of an oxygen generating container in a mask according to an embodiment of the present disclosure. FIG. 9 is a diagram illustrating an operating portion coupled to a cover member in a mask according to an embodiment of the present disclosure.

Referring to FIGS. 5 to 9, the oxygen generating container of an embodiment of the present disclosure will be described in more detail. The oxygen generating container 500 may include: a container body 510 that is coupled to the filter sheet 100, and includes an edge portion 520 formed by having one side open and the other side closed to form an accommodation space (C) inside and being bent in a flange shape and a step 530 formed by being bent in an inner accommodation space (C); a barrier frame 300 that includes a plurality of air passages 310, is accommodated inside the container body 510, is seated on the step 520, and is coupled to the container body 510; and a cover member 400 that is coupled to an upper end of the edge portion 520 of the container body 510 to seal the oxygen generating substance 10 inside. In addition, there may be further included the coupling frame 550 adapted to couple the container body 510 to the filter sheet 100 by interposing the filter sheet 100 on a rear surface of the edge portion 520 of the container body 510.

The closed other side of the container body 510 is inserted into the empty space formed inside the filter sheet 100, and the coupling frame 550 is disposed on the other side of the filter sheet 100, so that the container body 510 may be coupled to the filter sheet 100 interposed in the middle by the coupling of the container body 510 and the coupling frame 550. In addition, a bag containing the oxygen generating substance is disposed in the space inside the container body 510, and the barrier frame 300 is seated on and coupled to the step 530 on an upper portion thereof to prevent the oxygen generating substance from leaking out, while allowing gas or moisture to move. The cover member 400 is coupled to an upper portion of the container body 510 to seal the inside of the container body 510. As shown in FIG. 6, when the cover member 400 is removed and moisture and carbon dioxide are introduced as the oxygen generating substance, a reaction that generates oxygen may begin.

In other words, the container body 510 may be open on one side and closed on the other side to form the accommodation space (C) inside, may be formed in a flange shape to form the edge portion 520, and may be coupled to the filter sheet 100. The container body 510 may be provided with the accommodation space (C) inside to store the oxygen generating substance and coupled to the filter sheet 100. When a user removes the cover member 400, carbon dioxide and moisture are provided to the oxygen generating substance 10 accommodated through the opened one side to cause a reaction and generate oxygen. Accordingly, oxygen may be supplied to the respiratory tract of a user and the survival time of the user may be increased.

The container body 510 is configured in a form in which the other side, in other words, the lower surface, is closed and one side, in other words, the upper surface, is open, so that oxygen may pass only in the direction of the respiratory tract of a user and external toxic gases may be prevented from passing into the respiratory tract of the user. In other words, the closed portion on the other side of the container body 510 and the outer surface of the filter sheet 100 may form one closed surface on the outer surface based on the face of a user, and the supply of moisture or carbon dioxide to the oxygen generating substance and the supply of oxygen through a reaction may be carried out on the inner surface of the filter sheet 100, which is the surface facing the user.

The coupling frame 550 may couple the container body 510 to the filter sheet 100 by interposing the filter sheet 100 on the rear surface of the edge portion 520 of the container body 510. In other words, the coupling frame 550 may perform the function of fixing the container body 510 to the filter sheet 100 by coupling the filter sheet 100 while being interposed on the other surface (rear surface) of the edge portion 520 forming the open upper surface of the container body 510. The coupling of the coupling frame 550 and the container body 510 with the filter sheet 100 interposed therebetween may be performed by ultrasonic welding, but is not limited thereto, and may be performed by a thermal welding method. The oxygen generating container 500 may be maintained in a state of being coupled to the filter sheet 100 by the coupling frame 550.

The barrier frame 300 may have the plurality of air passages 310 formed therein, may be accommodated inside the container body 510, and may be coupled to the container body 510. The barrier frame 300 may be coupled or bonded by the components disposed while being seated on the step 530 in an empty space (C) inside the container body 510, and for example, may be coupled by a concavo-convex (L) coupling or bonded by a separate adhesive layer. However, in order to prevent the generation of toxic gases from adhesive materials in high-temperature environments such as fires, coupling by physical configurations, such as a concavo-convex coupling or a fitting coupling, may be desirable. This will be described in more detail later.

The barrier frame 300 may prevent (block) the bag accommodating the oxygen generating substance in the container body 510 from leaking out. The air passages 310 composed of a plurality of empty spaces of the barrier frame 300 may serve as a passage function to allow oxygen to move to the outside of the container body 510 while preventing the oxygen generating substance 10 from escaping, thereby acting as a passage for oxygen movement. In other words, the barrier frame 300 may perform the function of accommodating a relatively large volume of the oxygen generating substance 10 in an inner empty space (C) of the container body 510 and preventing the same from escaping to the outside while allowing gas to pass through, thereby allowing gases such as carbon dioxide or moisture introduced and oxygen generated to easily flow in and out.

The cover member 400 may be coupled to the upper end of the edge portion 520 of the container body 510 to seal the oxygen generating substance 10 inside. In addition, the cover member 400 may include a protruding area 430 protruding further from the edge portion 520 of the container body 510. In other words, the cover member 400 may include a coupling area 420 that is coupled along the surface of the edge portion 520 of the container body 510, an inner area 410 that is present on an inner side of the coupling area 420 and faces the empty space and barrier frame on the inside of the container body 510, and the protruding area 430 that is present on the outer side of the coupling area 420 and protrudes to be closer to a specific direction. The coupling area 420 of the cover member 400 may be coupled to the upper end of the edge portion 520 of the container body 510 and form a closed curve with a shape corresponding to the surface shape of the edge portion 520 so as to completely seal the oxygen generating substance 10 inside. Accordingly, the empty space (C) inside the container body 510 may be completely sealed to maintain excellent airtightness.

The protruding area 430 of the cover member may be designed to easily remove the cover member 400 by hand when a user intends to remove the cover member 400 from the container body 510 to use the mask (in other words, when a situation arises where oxygen is required to be generated), and may be formed to protrude outward from the coupling area 420 but not to extend beyond the area formed by the filter sheet 100. Accordingly, when the mask is stored when not in use, the protruding area 430 of the cover member 400 is located only on the inside of the filter sheet 100, thereby preventing the cover member 400 from being unintentionally separated. When the protruding area 430 of the cover member 400 is formed wider (larger, further) than the area where the filter sheet 100 is formed and is exposed to the outside of the filter sheet 100, a force may be applied to the cover member from the outside of the filter sheet of the mask, and the cover member may be unintentionally separated or a leak may occur in the sealing portion, thereby reducing the airtightness. Accordingly, the protruding area 430 of the cover member 400 may be formed only in the inner area of the filter sheet 100, thereby preventing the airtightness from being reduced.

The cover member 400 may have a multilayer structure composed of one or a mixed layer selected from the group consisting of polypropylene (PP), ethylene vinyl alcohol (EVOH), polycarbonate (PC), polyvinyl chloride (PVC), polyethylene terephthalate (PET), and aluminum foil to maintain airtightness and effectively block moisture. In order to effectively block moisture while preventing the cover member 400 from being easily damaged, it may be preferable that the surface facing the inner empty space (C) of the container body 510 be formed of a layer made of a material including aluminum foil.

There may be further included an operating portion 600 coupled to the protruding area 430 of the cover member 400. In addition, the protruding area 430 where the operating portion 600 of the cover member 400 is coupled may be disposed in a downward direction based on the face of a user. The operating portion 600 may be formed of a hard material molded from various resin materials, and may enable a user to grip and separate the cover member 400 more easily and quickly. The operating portion 600 may be formed of a polymer resin material such as, for example, polypropylene (PP) resin material, polycarbonate (PC) resin material, or a mixture thereof, but is not particularly limited thereto.

It may be understood that the cover member 400 is configured to be easily separated by a user by a material that is formed firmly, unlike other soft materials, in an emergency disaster situation or a situation that requires urgent use by the operating portion 600. The cover member 400 that is firmly coupled to the edge portion 520 of the container body 510 may be separated more easily by gripping the relevant portion and applying a force to separate the cover member 400. The operating portion 600 may have Braille formed or a separate mark (letters) engraved or embossed so as to check a position where the cover may be separated even in an invisible situation, and may be formed during the process of injecting the operating portion 600.

The operating portion 600 may be disposed in a downward direction based on the face of a user to make it easier to remove the cover member 400. The shape of a human face generally becomes narrower in area toward the chin than toward the cheekbones or cheeks. When the operating portion 600 is disposed in the downward direction based on the face of a user, a lot of space is formed for the user to manipulate the operating portion 600 by hand, thus making it easier to remove the cover member 400.

The operating portion 600 may include a first plate 610 disposed on one surface of the cover member 400 and including a penetrating groove portion 630, a second plate 620 disposed on the other surface of the cover member and including a protruded coupling pillar 640 penetrating the cover member and coupled to the groove portion 630, and a cavity 650 formed as an empty space at a connecting portion of the first plate 610 and the second plate 620, wherein the first plate 610 and the second plate 620 may be formed integrally and coupled to the cover member in a folded state at one end.

Specifically, the operating portion 600 may include the first plate 610 disposed on one surface of the cover member 400 and including the groove portion 630, and the second plate 620 disposed on the other surface of the cover member and including the protruded coupling pillar 640, wherein the coupling pillar 640 may penetrate the cover member 400 and may be coupled to the groove portion 630. The operating portion 600 may have the groove portion 630 formed in the first plate 610, and the coupling pillar 640 facing the groove portion 630 may be formed in the second plate 620 opposite to the first plate 610, so that the groove portion 630 and the coupling pillar 640 are coupled to each other. Accordingly, the first plate 610 and the second plate 620 may be coupled to the cover member 400. Accordingly, the cover member 400 may be more easily removed from the container body 510 by manipulation of the operating portion 600.

The first plate 610 and the second plate 620 of the operating portion 600 are formed integrally and coupled to the cover member 400 in a folded state at one end. The operating portion 600 may be formed integrally by injection molding, and the position where the first plate 610 and the second plate 620 are connected may be folded so that the first plate 610 and the second plate 620 face each other, and the groove portion 630 and the coupling pillar 640 face each other. Accordingly, the operating portion 600 may be easily coupled and fixed to the cover member 400. In addition, when the cover member 400 is separated from the operating portion 600 by the coupling of the groove portion 630 and the coupling pillar 640, the operating portion 600 may be prevented from easily escaping from the cover member 400 due to an external force.

The cavity 650 may be formed at a location where the first plate 610 and the second plate 620 are connected, may be formed at a location where the first plate 610 and the second plate 620 are folded, and may be formed as an empty space. As shown in the drawing, the first plate 610 and the second plate 620 may be connected at both side ends, and the central portion may be formed as an empty space. Accordingly, the operating portion formed integrally may be coupled to the cover member to manufacture the mask in a simplified process, while minimizing the weight of the operating portion and thus minimizing the weight of the mask.

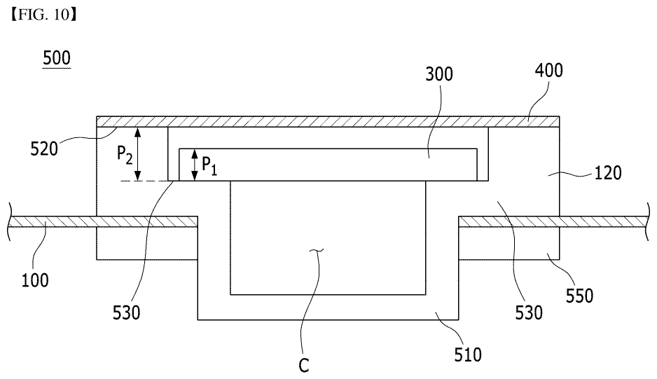

FIG. 10 is a diagram illustrating a cross-section taken along line A-A′ in FIG. 7 according to an embodiment.

Referring again to FIGS. 7 to 10, the barrier frame 300 may be seated on the step 530 formed inside the container body 510 and coupled. In addition, the barrier frame 300 may be coupled through various methods, such as using a separate coupling member such as an adhesive or physical coupling such as a concavo-convex ( [symbol] ) coupling. A height (P₂) from an upper surface of the step 530 of the container body 510 to an upper end of the edge portion 520 of the container body 510 may be equal to or higher than a height (P₁) from the upper surface of the step 530 of the container body 510 to an upper end of the barrier frame 300. In other words, the height (P₂) from the upper surface of the step 530 of the container body 510 to the upper end of the edge portion 520 of the container body 510 may be equal to the height (P₁) from the upper surface of the step 530 of the container body 510 to the upper end of the barrier frame 300, or the height (P₂) from the upper surface of the step 530 of the container body 510 to the upper end of the edge portion 520 of the container body 510 may be higher than the height (P₁) from the upper surface of the step 530 of the container body 510 to the upper end of the barrier frame 300.

In other words, the upper end of the barrier frame 300 may be formed at a position equal to or lower than the horizontal plane on which the cover member 400 is coupled to the edge portion 520 of the container body 510. When the cover member 400 is coupled to the edge portion 520 of the container body 510, the upper surface of the barrier frame 300 may be bonded to the lower surface of the cover member 400 and be configured at the same height. Alternatively, when the cover member 400 is coupled to the edge portion 520 of the container body 510, the upper surface of the barrier frame 300 is prevented from contacting the lower surface of the cover member 400, thereby preventing the barrier frame 300 from affecting the cover member 400 and reducing the airtightness. In other words, the coupling force between the cover member 400 and the edge portion 520 may be increased by avoiding contact with any portion other than the edge portion 520 where the cover member 400 is coupled to the container body 510, and the coupling force may be prevented from being weakened by other portions. Even when the cover member 400 comes into contact with the barrier frame 300, the lower surface of the cover member 400 and the upper surface of the barrier frame 300 are substantially disposed on the same horizontal plane, thereby preventing a decrease in the airtightness of the cover member 400.

In the past, the barrier frame was disposed on an upper edge of the container body, and a sealing member was formed on an upper portion of the barrier frame to seal the upper portion of the barrier frame and the container body to ensure airtightness, and then the space between the barrier frame and the sealing member had to be sealed again to ensure airtightness. In this connection, there was an issue in that the airtightness of other locations would be reduced during the two sealing processes. In particular, ultrasonic welding is mainly used to increase airtightness, prevent damage to the sealing material, and achieve rapid production. However, during this process, the airtightness of the portion that was processed first may be reduced. Accordingly, as in an embodiment of the present disclosure, the barrier frame 300 is seated on the step 530 inside the container body 510, and the height of the barrier frame 300 is made equal to or lower than the height of the cover member 400, thereby preventing a decrease in airtightness. In other words, the airtightness may be increased by ensuring that the upper surface of the barrier frame 300 is in contact with the lower surface of the cover member 400 but is disposed on the same horizontal plane, or by ensuring that the upper surface of the barrier frame 300 is not in contact with the lower surface of the cover member 400 (by ensuring that the barrier frame and the cover member are not substantially in contact). In other words, only the upper surface of the edge portion 520 of the container body 510 is made to contact the cover member 400, the cover member 400 is coupled and sealed only through this portion, and the impact applied to the cover member 400 at other locations is minimized, thereby maximizing the airtightness.

In order to prevent a decrease in airtightness, it is preferable that the barrier frame 300 is disposed spaced apart from the cover member 400 inside of the container body 510. Alternatively, the cover member 400 may be coupled (bonded) only to the edge portion 520 of the container body 510, and the barrier frame 300 may not be coupled (bonded) to the cover member 400. In other words, the barrier frame 300 may partially come into contact with the cover member 400, but are not in a coupled state. Accordingly, when the cover member 400 is separated and removed, the barrier frame 300 may not be affected.

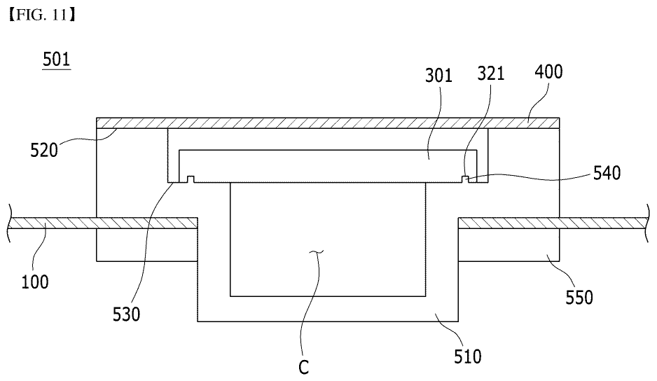

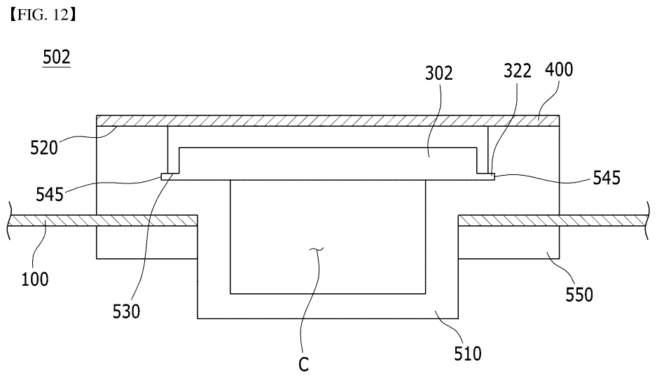

FIG. 11 is a diagram illustrating a cross-section taken along line A-A′ in FIG. 7 according to another embodiment. In addition, FIG. 12 is a diagram illustrating a cross-section taken along line A-A′ in FIG. 7 according to yet another embodiment.

Referring to FIGS. 11 and 12, the barrier frame 300 may further include a hole 321 or a protruded projection portion 322, and the container body 510 may further include a projection portion 540 or a hole 545 that may face and be concavo-convex ( [symbol] ) coupled to the hole 321 or the protruded projection portion 322 of the barrier frame 300. The above may be formed in various directions, such as vertically or horizontally on a vertical line. The hole 321 or the protruded projection portion 322 of the barrier frame 300 and the projection portion 540 or the hole 545 formed on an inner side of the container body 510 may be concavo-convex ( [symbol] ) coupled to each other to form an oxygen generating container 501, 502 so that the barrier frame 301, 302 does not separate from the container body 510. Accordingly, even when a user separates and uses the cover member 400, the barrier frame may be separated to prevent the oxygen generating substance inside from escaping to the outside. However, the coupling of the barrier frame to the container body is not limited to the concavo-convex coupling, and the coupling may be performed in various ways, such as by bonding using a separate adhesive material.

An embodiment of the present disclosure provides a method for manufacturing the mask. Hereinafter, a method for manufacturing a mask according to various embodiments of the present disclosure will be described with reference again to the above-described drawings. The method for manufacturing the mask of an embodiment of the present disclosure may be applied to the configurations of all of the various embodiments of the mask described above, and any redundant descriptions will be omitted. However, even when redundant descriptions are omitted, each configuration may be applied to the method for manufacturing the mask of an embodiment of the present disclosure.

The method for manufacturing the mask according to an embodiment of the present disclosure includes: preparing the filter sheet 100; interposing and disposing, on one surface of the filter sheet 100, a rear surface of the edge portion 520 of the container body 510 including the edge portion 520 having one side open and the other side closed to form an accommodation space inside and formed along an outer circumference of the upper surface by being bent in a flange shape and the step 530 formed by being bent in an inner accommodation space; coupling the container body coupled by disposing the coupling frame 550 while facing the rear surface of the edge portion 520 of the container body 510 with the filter sheet 100 interposed therebetween; disposing the bag 10 containing the oxygen generating substance in the accommodation space (C) of the container body 510; disposing the barrier frame 300 including a plurality of air passages 310 by accommodating the same inside the container body 510 and disposing the same by seating and coupling the same to the step 530; coupling and sealing the cover member 400 to an upper end of the edge portion 520 of the container body 510; and bonding the wearing strap 200 including two or more first wearing straps 210 and second wearing straps 220 of different lengths at both ends of the filter sheet 100.

In addition, the coupling of the container body 510 may be configured to couple the other surface of the edge portion 520 of the container body 510 and the coupling frame 550 to the filter sheet 100 interposed therebetween by ultrasonic welding or thermal welding. In addition, the sealing may be configured to couple an upper end of the edge portion 520 of the container body 510 and the cover member 400 by ultrasonic welding.

In addition, when the cover member 400 is coupled to the container body 510 by the sealing, the barrier frame 300 may not come into contact with the cover member 400, and the upper end of the edge portion 520 of the container body 510 may be higher than the height of the barrier frame 300. Accordingly, the barrier frame 300 may increase the airtightness between the edge portion 520 of the container body 510 and the cover member 400 without affecting the sealing. By limiting the stage for maintaining airtightness by performing the conventional multiple stages to only one stage between the edge portion 520 of the container body 510 and the cover member 400, airtightness may be increased and the process may be simplified.

The coupling of the container body may be performed by coupling the rear surface of the edge portion of the container body and the coupling frame through ultrasonic welding while the filter sheet is interposed, and the sealing may be performed by coupling the upper surface of the edge portion of the container body and the cover member 400 to the container body 510 through ultrasonic welding. In the sealing, the barrier frame 300 is seated on the step 530 formed in the inner empty space (C) of the container body 510, and is formed at a low height so as not to come into contact with the cover member 400, thereby not affecting the sealing of the cover member 400 and increasing the airtightness of the oxygen generating container 500.

The barrier frame 300 may be bonded to the container body 510 by a concavo-convex coupling or by a bonding material, and may be coupled to the container body 510 in various other ways. The form and various forms of couplings of the container body 510 and the barrier frame 300 have already been sufficiently described above, so any redundant description will be omitted.

The bonding of the wearing straps may be configured to bond the first wearing straps 210 and the second wearing straps 220 simultaneously. The first wearing straps 210 and the second wearing straps 220 may be formed of an elastic material, the first wearing straps 210 may be shorter than the second wearing straps 220, and the first wearing straps 210 may be less elastic than the second wearing straps 220. As such, even when a plurality of wearing straps 210, 220 of different lengths are bonded to the same position of the filter sheet 100, an equal force is applied to the mechanical device handling the first wearing straps 210 and the second wearing straps 220, thereby enabling more precise bonding (or coupling).

The first wearing straps 210 and the second wearing straps 220 may be bonded at the same point in the filter sheet 100. In addition, there may be further included the first reinforcing strap 160 that is physically coupled while penetrating the filter sheet 100 in a state in which the first wearing straps 210 and the second wearing straps 220 are interposed in the filter sheet 100. In this regard, this has already been described in the description of the mask, so any duplicate explanation will be omitted.

The first wearing straps 210 and the second wearing straps 220 may be formed of an elastic material, the first wearing straps 210 may be shorter than the second wearing straps 220, and the first wearing straps 210 may be less elastic than the second wearing straps 220. The difference in length between the first wearing straps 210 and the second wearing straps 220 and the characteristics due to an elastic force have already been described in the description of the mask, so any duplicate description will be omitted.

In addition, the filter sheet 100 may further include a second reinforcing strap 170 in which a first surface 110 and a second surface 120 facing each other are bonded by ultrasonic bonding, and at the distal end where the first surface 110 and the second surface 120 face each other, the first surface 110 and the second surface 120 repeatedly pass and are physically coupled. As the second reinforcing strap 170 has already been described in the description of the mask, any redundant description will be omitted.

There may be further included a liquid natural extract contained in the filter sheet 100. The types of ingredients that may be contained in the natural extract and the functions and roles of each ingredient have already been described in the description of the mask, so any redundant description will be omitted.

The oxygen generating container 500 may be coupled both to the first surface 110 and the second surface 120, thereby supplying more oxygen to a user. As this has already been described in the description of the mask, any redundant description will be omitted.

The oxygen generating container 500 may include: the container body 510 formed with the edge portion having one side open and the other side closed to form the accommodation space inside and formed in a flange shape; the coupling frame that couples the container body 510 to the filter sheet 100 by interposing the filter sheet 100 on the rear surface of the edge portion 520 of the container body 510; the barrier frame 300 formed with the air passages 310 formed with a plurality of empty spaces, accommodated on an inner side of the container body 510, and coupled to the container body 510; and the cover member 400 that is coupled to an upper end of the edge portion 520 of the container body 510 to seal the oxygen generating substance 10 inside. The barrier frame 300 may be disposed spaced apart from the cover member 400 inside of the container body 510.

In addition, the cover member 400 may include the protruding area 430 protruding further from the edge portion 520 of the container body 510, and further include the operating portion 600 coupled to the protruding area 430 of the cover member 400, wherein the protruding area 430 where the operating portion 600 of the cover member 400 is coupled may be disposed in a downward direction based on the face of a user.

In addition, the barrier frame 300 may be seated on the step 530 formed inside the container body 510 and coupled. A height (P₁) from the step 530 of the container body 510 to an upper end of the edge portion 520 of the container body 510 may be equal to or longer than a height (P₂) from the step 530 of the container body 510 to an upper end of the barrier frame 300.

In addition, the operating portion 600 may include the first plate 610 disposed on one surface of the cover member 400 and including the groove portion 630, and the second plate 620 disposed on the other surface of the cover member 400 and including the protruded coupling pillar 640, wherein the coupling pillar 640 may penetrate the cover member 400 and may be coupled to the groove portion 630, and wherein the first plate 610 and the second plate 620 may be formed integrally and coupled to the cover member 400 in a folded state at one end.

The specific embodiment of the oxygen generating container and the form of various embodiments that may be modified, the specific form of each component such as the cover member and the barrier frame, and the specific form and various embodiments of the operating portion have already been described in the description of the mask, so a detailed description of overlapping matters will be omitted.

Hereinbefore, the embodiments of the present disclosure have been described with reference to the attached drawings. It will be understood by those having ordinary skill in the technical field to which the present disclosure pertains that the present disclosure may be embodied in various other specific forms without departing from the technical ideas or essential characteristics thereof. Therefore, the disclosed embodiments should be considered in an illustrative rather than a restrictive perspective in all aspects.

What it claimed is:

1. A mask comprising:
a filter sheet;
an oxygen generating container coupled to the filter sheet;
an oxygen generating substance stored in a sealed state inside the oxygen generating container; and
wearing straps connected to both ends of the filter sheet,
wherein the wearing straps comprise at least two first wearing straps and second wearing straps of different lengths.

2. The mask of claim 1, wherein the first wearing straps and the second wearing straps are bonded at the same point in the filter sheet.

3. The mask of claim 2, further comprising a first reinforcing strap that is physically coupled while penetrating the filter sheet with the first wearing straps and the second wearing straps interposed in the filter sheet.

4. The mask of claim 1, wherein:
the first wearing straps and the second wearing straps are formed of an elastic material and the first wearing straps are shorter than the second wearing straps; and
the first wearing straps are less elastic than the second wearing straps.

5. The mask of claim 1, wherein:
the filter sheet has a first surface and a second surface facing each other bonded by ultrasonic bonding; and
the mask further comprises a second reinforcing strap, at a distal end where the first surface and the second surface face each other, that repeatedly passes through the first surface and the second surface and is physically coupled.

6. The mask of claim 5, further comprising a liquid natural extract contained in the filter sheet.

7. The mask of claim 1, wherein the oxygen generating container comprises:
a container body that is coupled to the filter sheet, and comprises an edge portion having one side open and the other side closed to form an accommodation space and bent in a flange shape and a step formed by being bent in an inner accommodation space;
a barrier frame that comprises a plurality of air passages, is accommodated inside the container body, and is seated on and coupled to the step; and
a cover member that is coupled to an upper end of the edge portion of the container body to seal the oxygen generating substance inside.

8. The mask of claim 7, wherein:
the cover member comprises a protruding area protruding further from the edge portion of the container body;
the mask further comprises an operating portion coupled to the protruding area of the cover member; and
the protruding area to which the operating portion of the cover member is coupled is disposed in a downward direction based on a face of a user.

9. The mask of claim 8, wherein:
the operating portion comprises a first plate disposed on one surface of the cover member and comprising a groove portion, a second plate disposed on the other surface of the cover member and comprising a protruded coupling pillar penetrating the cover member and coupled to the groove portion, and a cavity formed as an empty space at a connecting portion of the first plate and the second plate; and
the first plate and the second plate are formed integrally and coupled to the cover member in a folded state at one end.

10. The mask of claim 7, wherein the barrier frame further comprises a hole or a protruded projection portion, and the container body further comprises a projection portion or a hole that faces and forms a concavo-convex ( [symbol] ) coupling with the hole or protruded projection portion of the barrier frame.

11. The mask of claim 7, wherein a height from the step of the container body to an upper end of the edge portion of the container body is equal to or higher than a height from the step of the container body to an upper end of the barrier frame.

12. The mask of claim 7, wherein the barrier frame is disposed spaced apart from the cover member inside of the container body.

13. A method for manufacturing a mask, the method comprising:
preparing a filter sheet;
interposing and disposing, on one surface of the filter sheet, a rear surface of an edge portion of a container body comprising the edge portion having one side open and the other side closed to form an accommodation space and bent in a flange shape and a step formed by being bent in an inner accommodation space;
coupling the container body coupled by disposing a coupling frame while facing the rear surface of the edge portion of the container body with the filter sheet interposed therebetween;
disposing a bag accommodating an oxygen generating substance in the accommodation space of the container body;
disposing a barrier frame comprising a plurality of air passages by accommodating and disposing the same inside the container body and seating and coupling the same to the step;
coupling and sealing a cover member to an upper end of the edge portion of the container body; and
bonding wearing straps comprising two or more first wearing straps and second wearing straps of different lengths at both ends of the filter sheet.

14. The method of claim 13, wherein:
the coupling of the container body is configured to couple the rear surface of the edge portion of the container body and the coupling frame by ultrasonic welding while interposing the filter sheet; and
the sealing is configured to couple an upper surface of the edge portion of the container body and the cover member by ultrasonic welding.

15. The method of claim 13, wherein:
the bonding of the wearing straps is configured to bond the first wearing straps and the second wearing straps simultaneously; and
the first wearing straps and the second wearing straps are formed of an elastic material, the first wearing straps are shorter than the second wearing straps, and the first wearing straps are less elastic than the second wearing straps.
